(19) United States
(12) Patent Application Publication
(10) Pub. No.: US 2022/0177758 A1
(43) Pub. Date: Jun. 9, 2022

(54) METHOD AND COMPOSITION FOR REDUCING DUSTING FROM EXPOSED SURFACES OF STORED AND/OR DISPOSED BULK MATERIALS

(71) Applicant: BL Technologies, Inc., Minnetonka, MN (US)

(72) Inventors: Robert GREIFZU, Minnetonka, MN (US); Michael RAAB, Minnetonka, MN (US); Bryce UYTIEPO, Minnetonka, MN (US); Umit TURUNC, Minnetonka, MN (US)

(21) Appl. No.: 17/601,029

(22) PCT Filed: Feb. 27, 2020
(86) PCT No.: PCT/US2020/020085

§ 371 Date: Oct. 1, 2021

Related U.S. Application Data
(60) Provisional application No. 62/833,213, filed on Apr. 12, 2019.

(51) Int. Cl. C09K 3/22; C08L 97/02; C08J 9/00

(52) U.S. Cl. CPC C09K 3/22; C08L 97/02; C08J 2431/04; C08J 2397/02; C08J 9/0061

(57) ABSTRACT

A dust suppressant composition providing at least one water soluble plant-derived substance, and at least one synthetic polymeric resin. A method for dust suppression providing a dust suppressant composition, the composition having at least one water soluble plant-derived substance and at least one synthetic polymeric resin, and applying the dust suppressant composition to a plurality of exposed surfaces of bulk or granular materials.

### CROSS-REFERENCE TO RELATED APPLICATIONS

This application claims priority to U.S. Provisional Patent Application Ser. No. 62/833,213 filed Apr. 12, 2019, the entirety of which is herein incorporated by reference.

### FIELD OF INVENTION

The disclosed technology generally described hereinafter provides for a composition and method for dust suppression of fugitive emissions, and more specifically, a novel composition and method for significantly reducing fugitive emissions of dust and fine particles from the exposed surfaces of bulk and/or granular materials for long-term dust control efficacy.

### BACKGROUND OF THE INVENTION

Fugitive emission of dust and fine particles from bulk & granular materials is a significant environmental, safety and health concern. Common industrial processes that store and/or dispose granular materials outside, thus contributing to the emission of dust and fine particles, include mining, mineral processing, excavation, construction, civil-engineering, mineral ores and fuels extraction, transportation, storage and reclamation, processing and production of agricultural & forestry products, and their by-products.

For example, with tailings disposal, where the waste solid material from mining and mineral processing operations are pumped in slurry form to tailings dams or ponds, the disposed material eventually dries and causes significant dusting from its exposed surfaces. Another occurrence is observed with the storage of mineral ores, coal, coke, mineral concentrates, aggregates, sand and soils that are stored in open stockpiles. The exposed surfaces of these stockpiles can be significant source of dusting and contribute to the emission of dust and fine particles.

Generally, water is the most common short term solution to controlling of fugitive emissions from bulk and/or granular materials during storage and disposal. Water is usually sprayed onto the exposed surfaces of stored or disposed granular materials. However, water is only effective in the short term as it quickly evaporates off the exposed surfaces of storage and disposal areas and must be reapplied frequently to control dust.

Thus, what is needed in the art is a composition and method for significantly reducing fugitive emissions of dust and fine particles from the exposed surfaces of bulk and/or granular materials with long-term dust control efficacy.

### SUMMARY OF THE INVENTION

The disclosed technology generally described hereinafter provides for a composition and method for dust suppression of fugitive emissions.

In one aspect of the disclosed technology, a dust suppressant composition is provided. The dust suppressant composition comprises at least one water soluble plant-derived substance; and at least one synthetic polymeric resin.

In some embodiments, the at least one water soluble plant-derived substance comprises co-products or by-products obtained from the (i) pulp and paper industry, (ii) corn milling industry, (iii) sugar and starch processing industry, and (iv) biofuel industry. In some embodiments, the at least one water soluble plant-derived substance comprises lignins, ligno-sulfonates, sugars, molasses, modified starches, unmodified starches, or a combination thereof.

In some embodiments, the at least one synthetic polymeric resin comprises (i) acrylics, (ii) vinyl acrylates, (iii) vinyl acetates, (iv) vinyl acetate copolymers, (v) polyacrylamides, (vi) polyacrylamide copolymers, (vii) ethylene-vinyl acetate-maleate copolymers, and (viii) vinyl ester-versatic acid copolymers.

In some embodiments, the at least one synthetic polymeric resin is a vinyl acetate copolymer comprising (i) vinyl acetate-ethylene copolymers, (ii) vinyl acetate-acrylic acid copolymers, (iii) vinyl acetate-maleate copolymers, and (iv) vinyl acetate-vinyl chloride-ethylene terpolymers. In some embodiments, the at least one synthetic polymeric resin is a polyacrylamide copolymer comprising polyacrylamide-acrylic acid copolymers.

In some embodiments, the composition is a blend comprising between about 1-99% of the one water soluble plant-derived substance, and between 0.1-20% of the synthetic polymeric resin. In some embodiments, the composition is a solution or a foam. In some embodiments, the solution is an undiluted solution or a diluted solution.

In yet another aspect of the disclosed technology, a method for dust suppression is provided. The method comprises providing a dust suppressant composition, the composition comprising at least one water soluble plant-derived substance and at least one synthetic polymeric resin; and applying the dust suppressant composition to a plurality of exposed surfaces of bulk or granular materials.

In some embodiments, the at least one water soluble plant-derived substance comprises lignins, ligno-sulfonates, sugars, molasses, modified starches, unmodified starches, or a combination thereof. In some embodiments, the at least one synthetic polymeric resin comprises (i) acrylics, (ii) vinyl acrylates, (iii) vinyl acetates, (iv) vinyl acetate copolymers, (v) polyacrylamides, (vi) polyacrylamide copolymers, (vii) ethylene-vinyl acetate-maleate copolymers, and (viii) vinyl ester-versatic acid copolymers. In some embodiments, the composition is a blend comprising between about 1-99% of the one water soluble plant-derived substance, and between 0.1-20% of the synthetic polymeric resin.

In some embodiments, the bulk or granular materials comprises mineral ores, mineral concentrates, tailings, coal, coke, urea, fly-ash, coal combustion residue (CCR), phosphate rock, fertilizers, limestone, crushed stone, aggregates, sand, wood chips, saw-dust, waste derived fuels (WDF), hog fuel, and/or iron ore pellets.

In some embodiments, in the step of applying the dust suppressant composition the composition is applied as a solution or as a foam. In some embodiments, the composition is applied to the exposed surfaces of the bulk or granular materials during any one or more stages of extraction, production, processing, handling, storage, and transportation.

### BRIEF DESCRIPTION OF SEVERAL VIEWS OF THE DRAWINGS

These and other features of the disclosed technology, and the advantages, are illustrated specifically in embodiments now to be described, by way of example, with reference to the accompanying diagrammatic drawings, in which:

FIG. 1 is a graph providing results in accordance with an illustrative embodiment the disclosed technology.

### DETAILED DESCRIPTION OF EXEMPLARY EMBODIMENTS

The disclosed technology generally provides for a composition and method for dust suppression of fugitive emissions. More specifically, the disclosed technology significantly reduces fugitive emissions of dust and fine particles from the exposed surfaces of disposed bulk and/or granular materials.

The novel composition and method provide long-term dust control efficacy. It should be understood that long-term dust control efficacy in the context of the present disclosure is meant as a period greater than 24 hours. The present technology is more cost effective at providing long-term dust suppression than as compared with water, thus saving significant quantities of water and reducing application costs as compared with traditional water applications, such as water trucks or other spray systems.

The disclosed dust suppressant composition provides a “crust” when applied to the exposed surfaces of bulk exposed surfaces of disposed bulk and/or granular materials. As compared with other crusting agents, such as latexes, polymers, oils, resins, gums and various other film forming and/or adhesive materials that can form a crust or a thin film on bulk granular materials, the present technology provides a synergistic effect, thus allowing lower application costs as compared to other conventional crusting agents alone.

According to one aspect of the present technology, a novel dust suppressant composition is provided. The dust suppressant composition comprises at least one water soluble plant-derived substance, and at least one synthetic polymeric resin.

The water soluble plant-derived substance includes co-products or by-products obtained from industries, such as, but not limited to, the pulp and paper industry, corn milling industry, sugar and starch processing industry, and biofuel industry. In some embodiments, the water soluble plant-derived substance comprises lignins, ligno-sulfonates, sugars, molasses, modified starches, unmodified starches, and/or a combination thereof.

In some embodiments, the synthetic polymeric resin comprises acrylics, vinyl acrylates, vinyl acetates, vinyl acetate copolymers, polyacrylamides, polyacrylamide copolymers, ethylene-vinyl acetate-maleate copolymers, and/or vinyl ester-versatic acid copolymers.

In some embodiments, the synthetic polymeric resin is a vinyl acetate copolymer. In some embodiments, the synthetic polymeric resin comprises vinyl acetate-ethylene copolymers, vinyl acetate-acrylic acid copolymers, vinyl acetate-maleate copolymers, and/or vinyl acetate-vinyl chloride-ethylene terpolymers. In some embodiments, the synthetic polymeric resin is a polyacrylamide copolymer comprising polyacrylamide-acrylic acid copolymers.

The composition of the present technology is a blend comprising between about 1-99% of the one water soluble plant-derived substance, and between 0.1-20% of the synthetic polymeric resin. Water makes up the balance of the composition and/or is applied as a solution. In some embodiments, the composition can be applied as a solution or a foam. In some embodiments, the solution can be an undiluted (i.e. neat) or a diluted solution.

According to another aspect of the disclosed technology, a method for dust suppression is provided. The present method reduces and/or removes the fugitive emissions of dust and fine particles from the exposed surfaces of bulk and/or granular materials. These materials can be found at their respective storage and disposal areas, which include, but are not limited to, stockpiles, tailings dams and ponds, construction and excavation sites.

The method comprises providing a dust suppressant composition and applying the dust suppressant composition to the exposed surfaces of stored and/or disposed bulk or granular materials.

In some embodiments, the exposed surfaces include, but are not limited to, ore and tailings storage areas, stock-piles, tailings disposal areas, tailings dams, tailings ponds, waste rock storage areas and construction sites. In some embodiments, the disposed bulk and/or granular materials include, but are not limited to, ores, mineral concentrates, tailings, coal, coke, urea, fly-ash, coal combustion residue (CCR), phosphate rock, fertilizers, limestone, crushed stone, aggregates, sand, wood chips, saw-dust, waste derived fuels (WDF), hog fuel, and iron ore pellets.

The dust suppressant composition of the present method comprises at least one water soluble plant-derived substance and at least one synthetic polymeric resin. In some embodiments, the water soluble plant-derived substance comprises lignins, ligno-sulfonates, sugars, molasses, modified starches, unmodified starches, and/or a combination thereof.

In other embodiments, the synthetic polymeric resin comprises acrylics, vinyl acrylates, vinyl acetates, vinyl acetate copolymers, polyacrylamides, polyacrylamide copolymers, ethylene-vinyl acetate-maleate copolymers, and/or vinyl ester-versatic acid copolymers. In some embodiments, the synthetic polymeric resin comprises acrylics, vinyl acrylates, vinyl acetates, vinyl acetate copolymers, polyacrylamides, polyacrylamide copolymers, ethylene-vinyl acetate-maleate copolymers, and/or vinyl ester-versatic acid copolymers.

In some embodiments, the composition is a blend comprising between about 1-99% of the one water soluble plant-derived substance, and between 0.1-20% of the synthetic polymeric resin.

The method further comprises applying the dust suppressant composition to a plurality of exposed surfaces of bulk or granular materials. The bulk or granular materials may include, but not limited to, mineral ores, mineral concentrates, tailings, coal, coke, urea, fly-ash, coal combustion residue (CCR), phosphate rock, fertilizers, limestone, crushed stone, aggregates, sand, wood chips, saw-dust, waste derived fuels (WDF), hog fuel, and iron ore pellets.

The composition may be applied to the exposed surfaces of the bulk or granular materials as a solution or as a foam. In some embodiments, the composition can be applied to the exposed surfaces during any one or more stages of extraction, production, processing, handling, storage, and/or transportation.

### Examples

The present invention will be further described in the following examples, which should be viewed as being illustrative and should not be construed to narrow the scope of the disclosed technology or limit the scope to any particular embodiments.

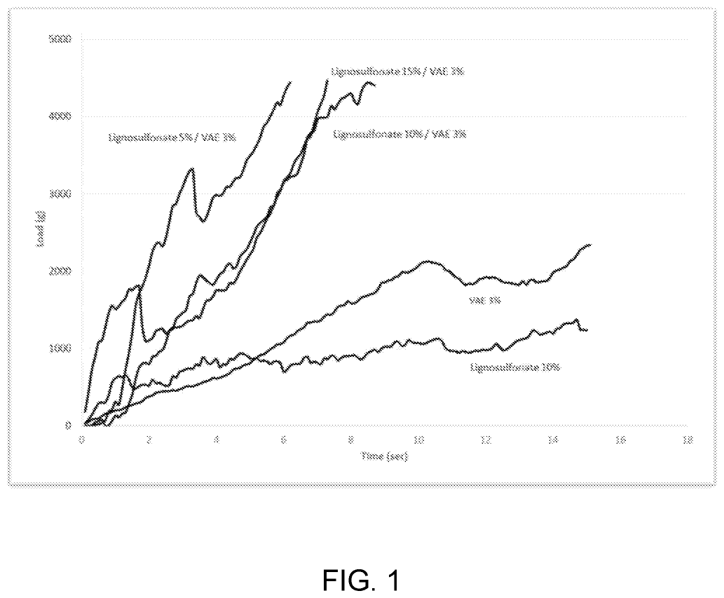

FIG. 1 exhibits the crust strength as grams of force required to break through the crust. Combinations of ligno-sulfonate and VAE latex are greater than the simple sum of the crust strength of 10% ligno-sulfonate and 3% VAE solutions.

A liquid sodium lignosulfonate product and a vinyl acetate-ethylene (VAE) copolymer latex were used as dust suppression agents on tailings from a copper mine. Solutions of lignosulfonate, with and without 3% added VAE were sprayed onto copper mine tailings samples. The treated tailings samples were allowed to dry and cure overnight. Next day, a Brookfield CT-3 texture analyzer was used to determine the crust strength of the treated tailings.

With the present composition and method, the crust strength of the lignosulfonate with 3% VAE was significantly higher than the sum of the crust strengths of lignosulfonate or VAE by itself, hence demonstrating synergy.

While embodiments of the disclosed technology have been described, it should be understood that the present disclosure is not so limited and modifications may be made without departing from the disclosed technology. The scope of the disclosed technology is defined by the appended claims, and all devices, processes, and methods that come within the meaning of the claims, either literally or by equivalence, are intended to be embraced therein.

1. A dust suppressant composition, comprising:
at least one water soluble plant-derived substance; and
at least one synthetic polymeric resin.

2. The composition as recited in claim 1, wherein the at least one water soluble plant-derived substance comprises co-products or by-products obtained from the (i) pulp and paper industry, (ii) corn milling industry, (iii) sugar and starch processing industry, and (iv) biofuel industry.

3. The composition as recited in claim 1, wherein the at least one water soluble plant-derived substance comprises lignins, ligno-sulfonates, sugars, molasses, modified starches, unmodified starches, or a combination thereof.

4. The composition as recited in claim 1, wherein the at least one synthetic polymeric resin comprises (i) acrylics, (ii) vinyl acrylates, (iii) vinyl acetates, (iv) vinyl acetate copolymers, (v) polyacrylamides, (vi) polyacrylamide copolymers, (vii) ethylene-vinyl acetate-maleate copolymers, and (viii) vinyl ester-versatic acid copolymers.

5. The composition as recited in claim 4, wherein the at least one synthetic polymeric resin is a vinyl acetate copolymer comprising (i) vinyl acetate-ethylene copolymers, (ii) vinyl acetate-acrylic acid copolymers, (iii) vinyl acetate-maleate copolymers, and (iv) vinyl acetate-vinyl chloride-ethylene terpolymers.

6. The composition as recited in claim 4, wherein the at least one synthetic polymeric resin is a polyacrylamide copolymer comprising polyacrylamide-acrylic acid copolymers.

7. The composition as recited in claim 1, wherein the composition is a blend comprising between about 1-99% of the one water soluble plant-derived substance, and between 0.1-20% of the synthetic polymeric resin.

8. The composition as recited in claim 1, wherein the composition is a solution or a foam.

9. The composition as recited in claim 8, wherein the solution is an undiluted solution or a diluted solution.

10. A method for dust suppression, the method comprising:
providing a dust suppressant composition, the composition comprising at least one water soluble plant-derived substance and at least one synthetic polymeric resin; and
applying the dust suppressant composition to a plurality of exposed surfaces of bulk or granular materials.

11. The method as recited in claim 10, wherein the at least one water soluble plant-derived substance comprises lignins, ligno-sulfonates, sugars, molasses, modified starches, unmodified starches, or a combination thereof.

12. The method as recited in claim 10, wherein the at least one synthetic polymeric resin comprises (i) acrylics, (ii) vinyl acrylates, (iii) vinyl acetates, (iv) vinyl acetate copolymers, (v) polyacrylamides, (vi) polyacrylamide copolymers, (vii) ethylene-vinyl acetate-maleate copolymers, and (viii) vinyl ester-versatic acid copolymers.

13. The method as recited in claim 10, wherein the composition is a blend comprising between about 1-99% of the one water soluble plant-derived substance, and between 0.1-20% of the synthetic polymeric resin.

14. The method as recited in claim 10, wherein the bulk or granular materials comprises mineral ores, mineral concentrates, tailings, coal, coke, urea, fly-ash, coal combustion residue (CCR), phosphate rock, fertilizers, limestone, crushed stone, aggregates, sand, wood chips, saw-dust, waste derived fuels (WDF), hog fuel, and/or iron ore pellets.

15. The method as recited in claim 10, wherein in the step of applying the dust suppressant composition the composition is applied as a solution or as a foam.

16. The method as recited in claim 10, wherein the composition is applied to the exposed surfaces of the bulk or granular materials during any one or more stages of extraction, production, processing, handling, storage, and transportation.
